(19) United States
(12) Patent Application Publication
(10) Pub. No.: US 2018/0102097 A1
(43) Pub. Date: Apr. 12, 2018

(54) DISPLAY DEVICE

(71) Applicant: InnoLux Corporation, Miao-Li County (TW)

(72) Inventors: Ching-Yu CHENG, Miao-Li County (TW); Tai-Chieh HUANG, Miao-Li County (TW); Ming-Feng HSIEH, Miao-Li County (TW)

(21) Appl. No.: 15/724,815

(22) Filed: Oct. 4, 2017

(30) Foreign Application Priority Data
Oct. 10, 2016 (CN) 201610883065.4

(51) Int. Cl. G09G 3/34; G09G 3/3208; G09G 3/36

(52) U.S. Cl. CPC G09G 3/342; G09G 3/3208; G06F 3/041; G09G 2330/021; G09G 3/36

(57) ABSTRACT

A display device includes a first light-emitting unit, a first driving unit, a second driving unit, a first circuit balance unit, and a second circuit balance unit. The first light-emitting unit includes a first lighting region and a second lighting region. The first driving unit is electrically connected to the first lighting region, and the second driving unit is electrically connected to the second lighting region. The first current balance unit is electrically connected to the first lighting region, and the second current balance unit is electrically connected to the second lighting region.

### CROSS REFERENCE TO RELATED APPLICATIONS

This Non-provisional application claims priority under 35 U.S.C. § 119(a) on Patent Application No(s). 201610883065.4 filed in People's Republic of China on Oct. 10, 2016, the entire contents of which are hereby incorporated by reference.

### BACKGROUND

### Technical Field

The disclosure relates to a display device and, in particular, to a display device capable of increasing contrast.

### Related Art

With the development of technologies, flat display devices have been widely applied to various fields. Due to the advantages such as low power consumption, less weight, compact size and less radiation, the liquid crystal display (LCD) devices have gradually replaced the traditional cathode ray tube (CRT) display devices and been applied to various electronic products, such as mobile phones, notebook computers, liquid crystal TVs and liquid crystal screens. Since the liquid crystal molecules can't emit light itself, a backlight module is needed to provide light, which can pass through the LCD panel to generate a color image via the pixels of the panel.

Recently, the backlight source of the LCD panel usually utilizes the LED backlight module, and the LED dimming control method is applied to the backlight module (light-emitting module) for decreasing the energy of the dark region and increasing the energy of the bright region according to the analyzing result of the brightness distribution of the image, thereby achieving the purposes of compensating the image or increasing the dynamic contrast.

### SUMMARY

The present disclosure provides a display device including a first light-emitting unit, a first driving unit, a second driving unit, a first current balance unit, and a second current balance unit. The first light-emitting unit includes a first lighting region and a second lighting region. The first driving unit is electrically connected to the first lighting region, and the second driving unit is electrically connected to the second lighting region. The first current balance unit is electrically connected to the first lighting region, and the second current balance unit is electrically connected to the second lighting region.

As mentioned above, each light-emitting unit of the light-emitting module in the display device of the disclosure includes a plurality of lighting regions, and at least two of the lighting regions in each one of the light-emitting units are connected to at least two driving units. The plurality of lighting regions connected to the same one of the driving units are connected to the current balance unit corresponding to the driving unit. This configuration can effectively prevent the loading peak from one set of driving units.

### BRIEF DESCRIPTION OF THE DRAWINGS

The embodiments will become more fully understood from the detailed description and accompanying drawings, which are given for illustration only, and thus are not limitative of the present disclosure, and wherein:

FIG. 1A is a functional block diagram of a display device according to an embodiment of the disclosure;

FIG. 1B is a schematic diagram showing a part of the driving circuit of the display device of FIG. 1A;

FIG. 1C is a schematic diagram showing a circuit containing three components connected in serial and parallel;

FIG. 2 is a functional block diagram of a display device according to another embodiment of the disclosure;

FIG. 3 is a functional block diagram of a display device according to another embodiment of the disclosure; and

FIGS. 4A to 4D are schematic diagrams showing display devices of different aspects of the disclosure.

### DETAILED DESCRIPTION OF THE DISCLOSURE

The embodiments of the disclosure will be apparent from the following detailed description, which proceeds with reference to the accompanying drawings, wherein the same references relate to the same elements.

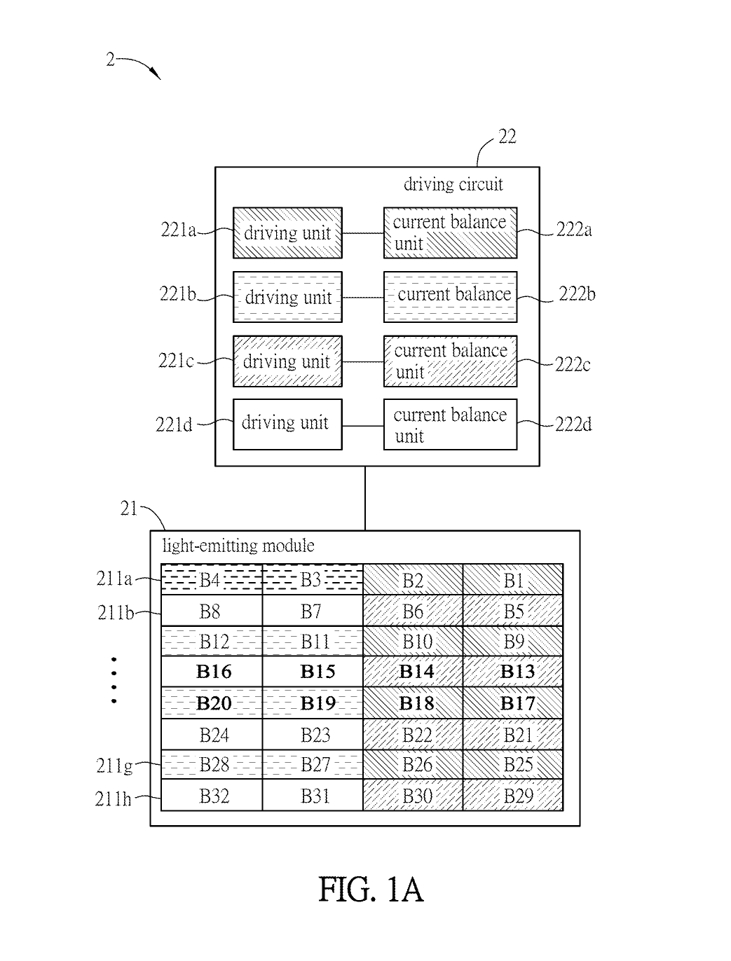

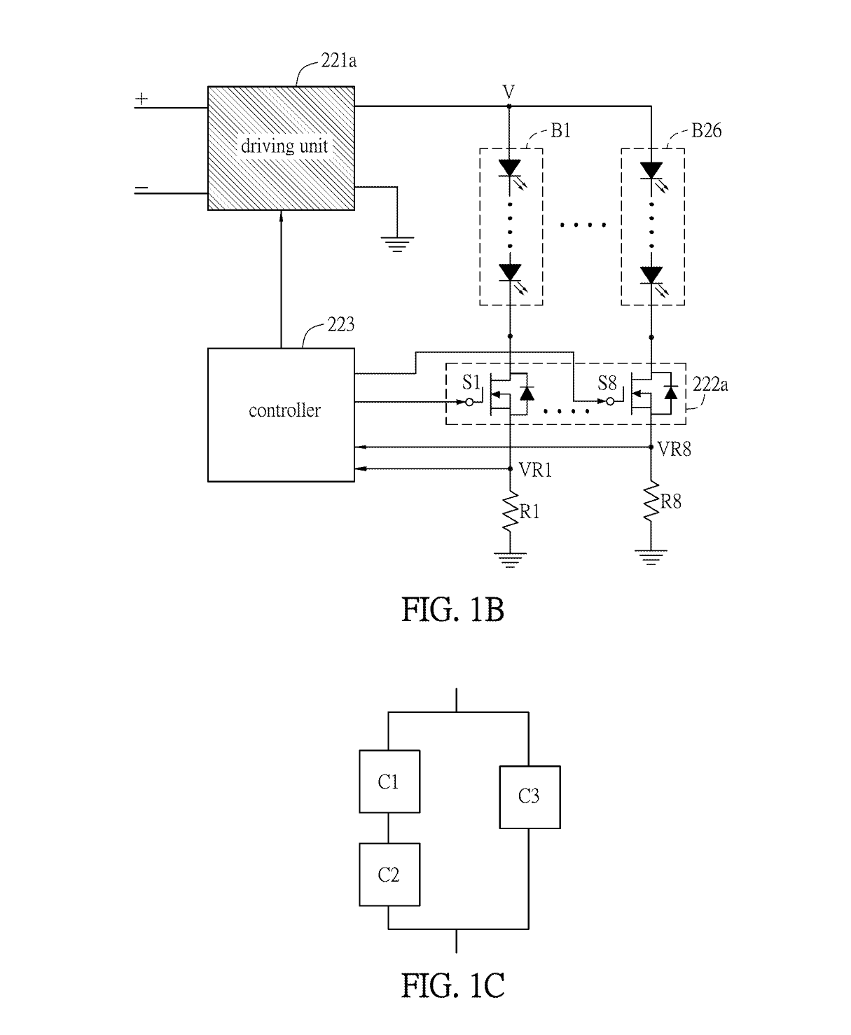

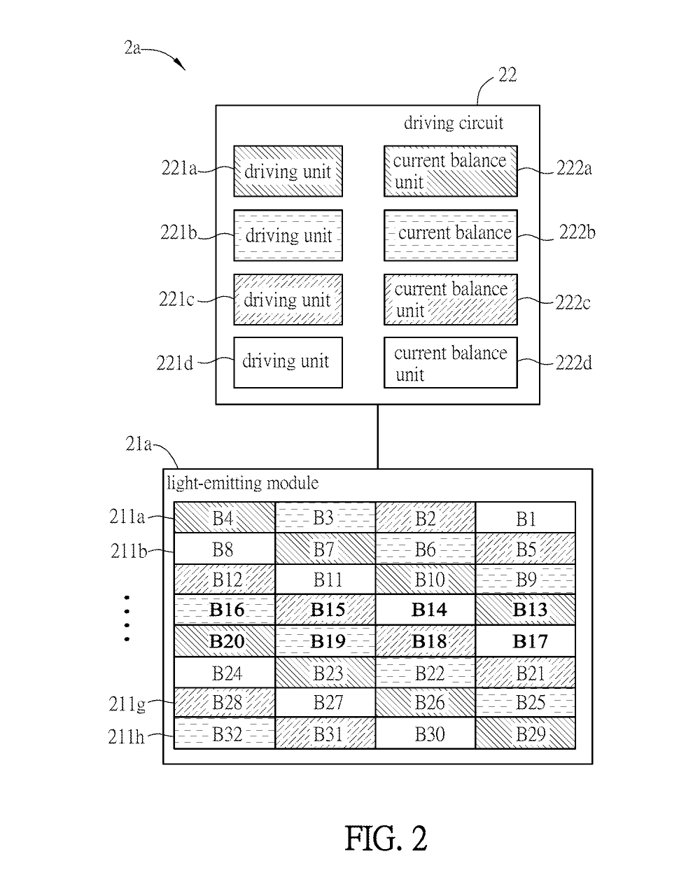

FIG. 1A is a functional block diagram of a display device 2 according to an embodiment of the disclosure, and FIG. 1B is a schematic diagram showing a part of the driving circuit 22 of the display device 2 of FIG. 1A.

Referring to FIGS. 1A and 1B, the display device 2 includes a light-emitting module 21 and a driving circuit 22, which are electrically coupled. In this embodiment, the light-emitting module 21 can be a direct-type backlight module, an edge-type backlight module, an LED module, an OLED module, or a μLED module. When the light-emitting module 21 is a direct-type backlight module or an edge-type backlight module, the display device 2 is an LCD device. When the light-emitting module 21 is an OLED module, the display device 2 is an OLED display device. When the light-emitting module 21 is a μLED module, the display device 2 is a μLED display device. This disclosure is not limited.

In this embodiment, the LED module can be a chip containing inorganic light emitting material for emitting light. The chip size of a normal LED module is in a range from 300 μm to 2 mm. The chip size of a mini-LED module is in a range from 100 μm to 300 μm. The chip size of a micro-LED (μLED) module is in a range from 1 μm to 100 μm.

The light-emitting module 21 includes a plurality of light-emitting units, and each light-emitting unit has at least one of LED elements or μLED elements. In this embodiment, the light-emitting module 21 includes eight light-emitting units 211a˜211h, and each of the light-emitting units 211a˜211h includes a plurality of lighting regions. Herein, each of the light-emitting units 211a˜211h can be, for example but not limited to, an LED light bar, and each LED light bar has at least four lighting regions. In more detailed, the light-emitting unit 211a has lighting regions B1˜B4, the light-emitting unit 211b has lighting regions B5˜B8, . . . , and the light-emitting unit 211h has lighting regions B29˜B32. To be noted, FIG. 1A shows the distribution of the light-emitting units 211a˜211h as viewing from the top, each of the lighting regions B1˜B32 has a corresponding lighting zone, and the lighting regions B1˜B32 (or a plurality of lighting regions) are arranged in a two-dimensional array in the plane. In one embodiment, the lighting regions B1˜B32 are arranged on a rectangular substrate or a non-rectangular substrate, and the substrate can be, for example but not limited to, a common substrate or a circuit board. In other embodiments, the lighting regions B1˜B32 are arranged in a three-dimensional array. In other embodiments, the LED light bars can have a bar shape or any desired and available shape.

The driving circuit 22 is electrically connected to the light-emitting units 211a˜211h for driving the light-emitting units 211a˜211h to emit light. In this embodiment, the driving circuit 22 has a plurality of driving units and a plurality of current balance units, and the driving units are disposed corresponding to the current balance units. The driving circuit 22 of this embodiment includes four driving units 221a, 221b, 221c and 221d and four current balance units 222a, 222b, 222c and 222d. In this case, the driving unit 221a is disposed corresponding to and electrically connected to the current balance unit 222a, . . . , and the driving unit 221d is disposed corresponding to and electrically connected to the current balance unit 222d. Each of the driving units 221a, 221b, 221c and 221d can be a DC-to-DC converter or an AC-to-DC converter. In this embodiment, the driving units 221a, 221b, 221c and 221d are DC-to-DC converters. Herein, the converters can be a flyback converter, a forward converter, a boost converter, a buck converter, a boost-buck converter, or a push-pull converter, and this disclosure is not limited. To be noted, the above-mentioned converters are well-known to the skilled persons in the art and disclosed in many related articles, and they are not the critical point of the disclosure, so the detailed descriptions of the circuit and content thereof will be omitted.

At least two of the lighting regions in one of the light-emitting units are connected to at least two of the driving units, and the plurality of lighting regions connected to the same one of the driving units are connected to the current balance unit corresponding to the driving unit. To be noted, the above-mentioned connection includes electrically connecting, electrically coupling, directly contacting, indirectly contacting, and the likes. In this embodiment, the four lighting regions of the light-emitting units 211a˜211h are connected to at least two driving units. To make the drawing more clear, FIG. 1A utilizes the same hatching lines to indicate the same connecting relation, which means that the lighting regions of the same hatching lines are connected to the driving unit and current balance unit of the same hatching lines. The light-emitting units 211a˜211h can be connected to the driving units 221a, 221b, 221c and 221d via flexible flat cable (FFC), flexible printed circuit (FPC), board-to-board connection, or wires. To be noted, each of the light-emitting units of the light-emitting module 21 of this embodiment is connected to at least two driving units, and one lighting region is correspondingly connected to one driving unit. Of course, in other embodiments, in a part of the light-emitting module 21, each light-emitting unit is connected to at least one of the driving units. In other words, each light-emitting unit is not needed to connect with at least two driving units. In a part of the light-emitting module, the light-emitting unit is connected to at least two driving units; and in another part of the light-emitting module, the light-emitting unit is connected to at least one driving unit. This disclosure is not limited.

In specific, two lighting regions B1 and B2 of the light-emitting unit 211a are connected to the driving unit 221a, two lighting regions B3 and B4 of the light-emitting unit 211a are connected to the driving unit 221b, two lighting regions B5 and B6 of the light-emitting unit 211b are connected to the driving unit 221c, two lighting regions B7 and B8 of the light-emitting unit 211b are connected to the driving unit 221d, . . . , two lighting regions B29 and B30 of the light-emitting unit 211h are connected to the driving unit 221c, and two lighting regions B31 and B32 of the light-emitting unit 211h are connected to the driving unit 221d. In this case, the four lighting regions of each of the light-emitting units 211a˜211h are connected to, for example, two of the driving units, and this disclosure is not limited.

The lighting regions B1, B2, B9, B10, B17, B18, B25 and B26, which are connected the same driving unit 221a, are connected to the current balance unit 222a, which is corresponding to the driving unit 221a. The lighting regions B3, B4, B11, B12, B19, B20, B27 and B28, which are connected the same driving unit 221b, are connected to the current balance unit 222b, which is corresponding to the driving unit 221b. The lighting regions B5, B6, B13, B14, B21, B22, B29 and B30, which are connected the same driving unit 221c, are connected to the current balance unit 222c, which is corresponding to the driving unit 221c. The lighting regions B7, B8, B15, B16, B23, B24, B31 and B32, which are connected the same driving unit 221d, are connected to the current balance unit 222d, which is corresponding to the driving unit 221d.

FIG. 1B shows the lighting regions B1, B2, B9, B10, B17, B18, B25 and B26 (only shows the lighting regions B1 and B26), which are connected to the driving unit 221a and connected to the current balance unit 222a corresponding to the driving unit 221a. The connections of the residual lighting regions, which connect to the driving units 221b, 221c and 221d and the corresponding current balance units 222b, 222c and 222d, respectively, can be referred to the following description with reference to FIG. 1B, so the detailed descriptions thereof will be omitted.

As shown in FIG. 1B, each of the lighting regions B1, . . . , and B26 has at least one of LED elements or μLED elements. If each of the lighting regions B1, . . . , and B26 has a plurality of LED elements or a plurality of μLED elements, the plurality of LED elements or the plurality of μLED elements are connected in serial, in parallel, or in serial and parallel. FIG. 1C shows the components connected in serial and parallel. As shown in FIG. 1C, two elements C1 and C2 are connected in serial, and they are connected to another element C3 in parallel. In this embodiment, each of the lighting regions B1, . . . , and B26 has the plurality of LED elements or the plurality of μLED elements connected in serial. This disclosure is not limited. In another embodiment, each of the lighting regions B1, . . . , and B26 has the plurality of LED elements or μLED elements connected in parallel. In another embodiment, some of the lighting regions B1, . . . , and B26 have the plurality of LED elements or μLED elements connected in serial, and some of the lighting regions B1, . . . , and B26 has the plurality of LED elements or μLED elements connected in parallel. In addition, the lighting regions B1, . . . , and B26, which are connected to the same driving unit 221a, have a common anode. This disclosure is not limited thereto. In some embodiments, the lighting regions B1, . . . , and B26, which are connected to the same driving unit 221a, have a common cathode. In some embodiments, some of the lighting regions B1, . . . , and B26, which are connected to the same driving unit 221a, have a common anode, and some of the lighting regions B1, . . . , and B26, which are connected to the same driving unit 221a, have a common cathode.

The driving circuit 22 further includes a controller 223 disposed corresponding to the driving unit 221a. In this embodiment, the controller 223 is connected with the driving unit 221a and the current balance circuit 222a. In another embodiment, two controllers are provided to connect with the driving unit 221a and the current balance circuit 222a, respectively, for respectively controlling the driving unit 221a and the current balance circuit 222a. The two controllers can be connected and communicated, and this disclosure is not limited. In this embodiment, the current balance circuit 222a includes eight switch elements S1˜S8 (only S1 and S8 are shown), which are disposed corresponding to the lighting regions B1, . . . , and B26 that connect to the driving unit 221a. In this case, the switch element S1 connects to the lighting region B1, the switch element S2 connects to the lighting region B2, the switch element S3 connects to the lighting region B9, . . . , and the switch element S8 connects to the lighting region B26.

The switch element S1 can be a transistor such as, for example but not limited to, MOSFET or BJT. In the design that the lighting regions B1, . . . , and B26 connecting to the same driving unit 221a have a common anode, a control end of the switch element S1 is connected to the controller 223, and the controller 223 can control to turn on or turn off the switch element S1. The first end of the switch element S1 is connected to the cathode of the last LED element in the lighting region B1, the second end of the switch element S1 is connected to one end of the resistor R1, and the other end of the resistor R1 is grounded. The other switch elements have similar design. For example, a control end of the switch element S8 is connected to the controller 223, and the controller 223 can control to turn on or turn off the switch element S8. The first end of the switch element S8 is connected to the cathode of the last LED element in the lighting region B26, the second end of the switch element S8 is connected to one end of the resistor R8, and the other end of the resistor R8 is grounded. Accordingly, the controller 223 can receive the end voltages VR1˜VR8 of the resistors R1˜R8, and perform a feedback control to correspondingly control the control ends of the switch elements S1˜S8 and the output voltage V of the driving unit 221a. Thus, in the light-emitting unit 211a, the currents flow through the lighting regions B1, . . . , and B26 are substantially the same, so the brightness of each of the lighting regions B1, . . . , and B26 are substantially equivalent. This configuration can achieve the goal of current balance. To be noted, the structure of the current balance unit 222a is not limited to the above embodiment, and any equivalent circuit thereof can be applied in this disclosure.

In the embodiment of FIG. 1A, when the energy is focused on the lighting regions B13˜B20 of the light-emitting module 21, the loading can be averagely distributed to the four driving units 221a, 221b, 221c and 221d. The driving units 221a, 221b, 221c and 221d can control the loading of two lighting regions, and effectively prevent the loading peak from focusing on one set of driving units. Accordingly, it is unnecessary to select expensive components and heat-dissipating elements for improving the performance of the driving units of the display device 2. In addition, although the display device 2 of this embodiment needs to design a complicated layout during the design stage, the design result can economically reduce the cost for manufacturing circuits and power consumption.

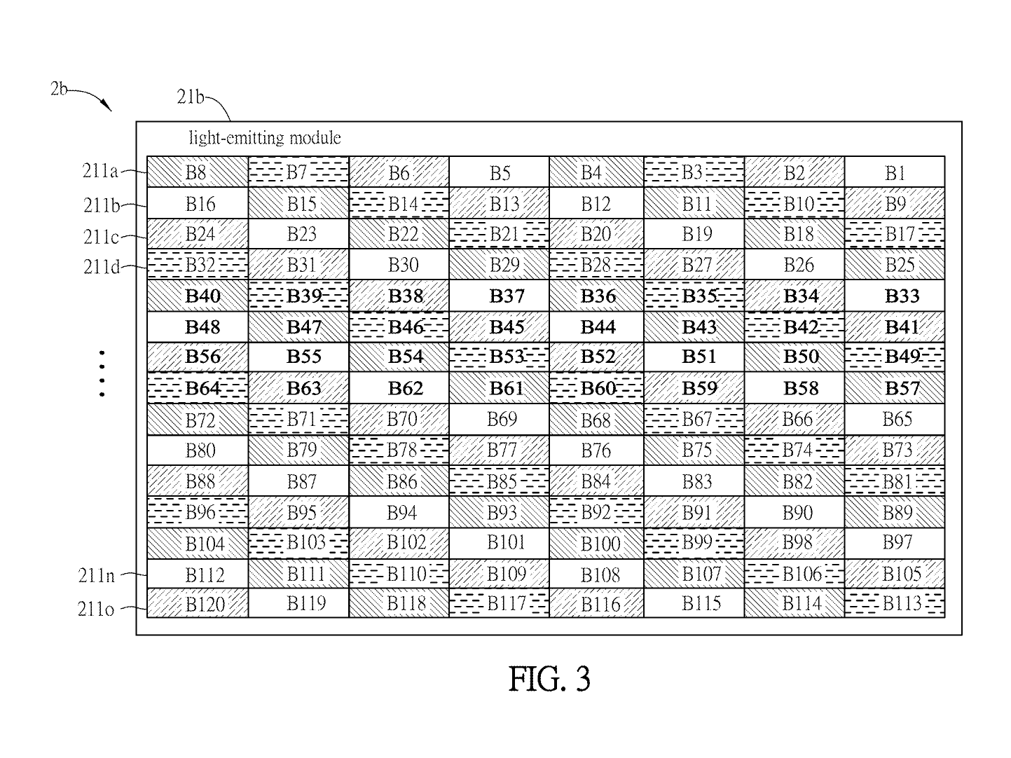

FIG. 2 is a functional block diagram of a display device 2a according to another embodiment of the disclosure.

The display device 2a of FIG. 2 has the light-emitting module 21a and the driving circuit 22, which are the same as those of the display device 2 of FIG. 1A. The connections between the light-emitting module 21a and the driving units 221a˜221d of the driving circuit 22 as shown in FIG. 2 are different from the connections of the display device 2 of FIG. 1A.

In this aspect, the light-emitting module 21a includes eight light-emitting units 211a˜211h, and each of the light-emitting units 211a˜211h has four lighting regions. The four lighting regions of each of the light-emitting units 211a˜211h are connected to four driving units 221a, 221b, 221c and 221d, respectively. To make the drawing more clearly, FIG. 2 utilizes the same hatching lines to indicate the connecting relations, which means that the lighting regions of the same hatching lines are connected to the driving unit and current balance unit of the same hatching lines.

In more specific, four lighting regions B1˜B4 of the light-emitting unit 211a are connected to the driving units 221a, 221b, 221c and 221d, respectively. In more detailed, the lighting region B1 is connected to the driving unit 221d, the lighting region B2 is connected to the driving unit 221c, the lighting region B3 is connected to the driving unit 221b, and the lighting region B4 is connected to the driving unit 221a. Four lighting regions B5˜B8 of the light-emitting unit 211b are also connected to the driving units 221a, 221b, 221c and 221d, respectively. The other lighting regions have similar connection relations. For example, four lighting regions B29˜B32 of the light-emitting unit 211h are also connected to the driving units 221a, 221b, 221c and 221d, respectively. To be noted, the above-mentioned connection relations are for illustrations only, and this disclosure is not limited thereto.

In this embodiment, the plurality of lighting regions B4, B7, B10, B13, B20, B23, B26 and B29, which are connected to the same driving unit 221a, are connected to the current balance unit 222a, which is disposed corresponding to the driving unit 221a. The plurality of lighting regions B3, B6, B9, B16, B19, B22, B25 and B32, which are connected to the same driving unit 221b, are connected to the current balance unit 222b, which is disposed corresponding to the driving unit 221b. The plurality of lighting regions B2, B5, B12, B15, B18, B21, B28 and B31, which are connected to the same driving unit 221c, are connected to the current balance unit 222c, which is disposed corresponding to the driving unit 221c. The plurality of lighting regions B1, B8, B11, B14, B17, B24, B27 and B30, which are connected to the same driving unit 221d, are connected to the current balance unit 222d, which is disposed corresponding to the driving unit 221d.

The other technical features of the light-emitting module 21a, the driving units 221a˜221d and the current balance units 222a˜222d of the display device 2a can be referred to the same components of the above embodiment, so the detailed descriptions thereof will be omitted.

In the embodiment of FIG. 2, when the energy is focused on the lighting regions B13˜B20 of the light-emitting module 21a of the display device 2a, the loading can be averagely distributed to the four driving units 221a, 221b, 221c and 221d. Each of the driving units 221a, 221b, 221c and 221d can averagely control the loading of two lighting regions to effectively prevent the loading peak from focusing on one set of driving units. Accordingly, it is unnecessary to select expensive components and heat-dissipating elements for improving the performance of the driving units of the display device 2a.

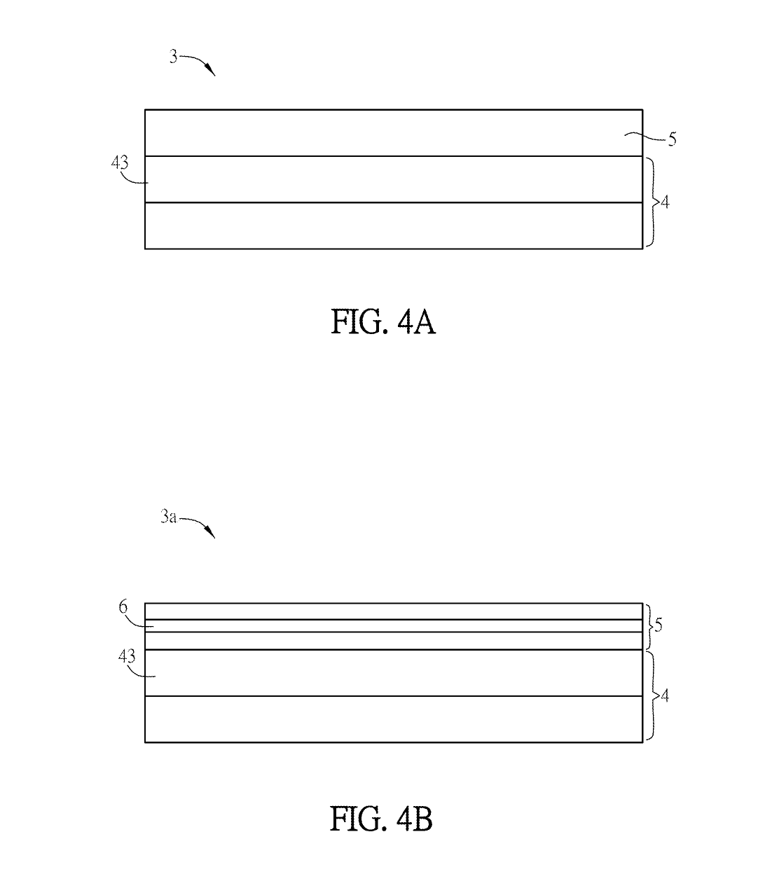

FIG. 3 is a functional block diagram of a display device 2b according to another embodiment of the disclosure. To be noted, FIG. 3 shows the distribution of the light-emitting units 211a˜211o (15 light-emitting units) as viewing from the top, and the four driving units 221a, 221b, 221c and 221d and the four corresponding current balance units 222a, 222b, 222c and 222d of the driving circuit 22 are not shown. The details of the driving units 221a, 221b, 221c and 221d and the current balance units 222a, 222b, 222c and 222d can be referred to the previous embodiment of FIG. 1A.

In the light-emitting module 21b of this aspect, each of the light-emitting units 211a˜211o has eight lighting regions, and the lighting regions of each of the light-emitting units 211a˜211o are connected to four driving units, respectively. For example, the light-emitting unit 211a has lighting regions B1˜B8. The lighting regions B4 and B8 are connected to the driving unit 221a, the lighting regions B3 and B7 are connected to the driving unit 221b, the lighting regions B2 and B6 are connected to the driving unit 221c, and the lighting regions B1 and B5 are connected to the driving unit 221d. The light-emitting unit 211b has lighting regions B9˜B16. The lighting regions B11 and B15 are connected to the driving unit 221a, the lighting regions B10 and B14 are connected to the driving unit 221b, the lighting regions B9 and B13 are connected to the driving unit 221c, and the lighting regions B12 and B16 are connected to the driving unit 221d. The other lighting regions have similar connection relations. To be noted, the connection relations between the lighting regions and the driving units of the light-emitting units 211c˜211o can be referred to FIG. 3, so the detailed description thereof will be omitted.

In addition, the plurality of lighting regions include a first lighting region and a plurality of second lighting regions, and the second lighting regions are disposed around and adjacent to the first lighting region. Besides, the second lighting regions are connected to two different driving units, and the driving unit connected to the first lighting region is different from the driving unit connected to the second lighting regions. In this embodiment, the first lighting region is the lighting region B37, and the second lighting regions are the lighting regions B29, B36, B38 and B45, which are disposed around the lighting region B37. The second lighting regions B29, B36, B38 and B45 are connected to two different driving units. In this case, the second lighting regions B29 and B36 are connected to the driving unit 221a, the second lighting regions B38 and B45 are connected to the driving unit 221c, and the first lighting region B37 is connected to the driving unit 221d. To be noted, the first lighting region B37 is not connected to the driving unit 221a or the driving unit 221c, and the driving unit connected to the first lighting region B37 is different from the driving units connected to the second lighting regions B29, B36, B38 and B45. Accordingly, the lighting regions of each of the light-emitting units 211a˜211h are averagely (or alternately) connected to the driving units 221a, 221b, 221c and 221d. In other embodiments, the plurality of second lighting regions can be connected to two or more different driving units, and this disclosure is not limited. In this embodiment, the second lighting regions B29, B36, B38 and B45 are from three different light-emitting units. In other embodiments, the second lighting regions B29, B36, B38 and B45 can be from one light-emitting unit.

In addition, one of the driving units 221a, 221b, 221c and 221d is connected to at least one of the lighting regions of every one of the light-emitting units 211a˜211o. In this embodiment, each of the driving units 221a, 221b, 221c and 221d is connected to two lighting regions of every one of the light-emitting units 211a˜211o, and this disclosure is not limited thereto. In other embodiments, each of the driving units 221a, 221b, 221c and 221d can be connected to at least one lighting region of a part of the light-emitting units 211a˜211o, and this disclosure is not limited thereto.

In the embodiment of FIG. 3, when the energy is focused on the lighting regions B33˜B64 of the light-emitting module 21b of the display device 2b, the loading can be averagely distributed to the driving units 221a, 221b, 221c and 221d. Each of the driving units 221a, 221b, 221c and 221d can averagely control the loading of eight lighting regions to effectively prevent the loading peak from focusing on one set of driving units. Accordingly, it is unnecessary to select expensive components and heat-dissipating elements for improving the performance of the driving units of the display device 2b.

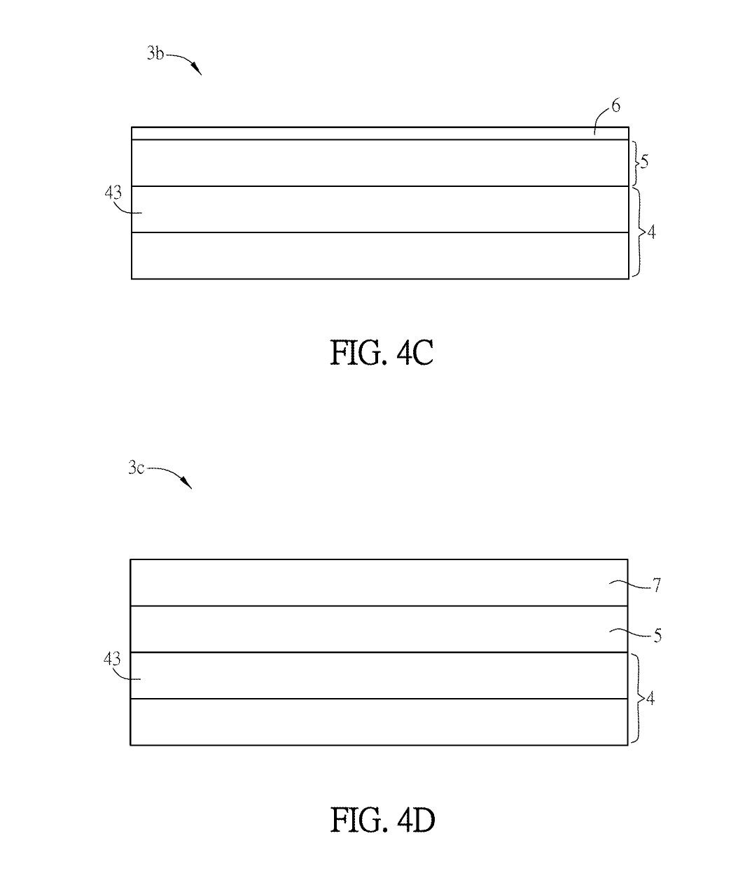

FIGS. 4A to 4D are schematic diagrams showing display devices 3, 3a, 3b and 3c of different aspects of the disclosure.

As shown in FIG. 4A, the display device 3 includes a light-emitting module 4 and a liquid crystal display (LCD) panel 5, which are disposed corresponding to each other. The light-emitting module 4 can emit light to the LCD panel 5, and the LCD panel 5 can display an image. In this embodiment, the display device 3 is an LCD device, and the light-emitting module 4 can be a direct-type backlight module or an edge-type backlight module. This disclosure is not limited. In addition, the light-emitting module 4 of this embodiment can be any one of the above-mentioned light-emitting modules 2, 2a and 2b, and their modifications. The technical features thereof can be referred to the above embodiments, so the detailed descriptions thereof will be omitted.

Besides, the light-emitting module 4 of this embodiment further includes an optical element 43, which is disposed corresponding to the LCD panel 5. The light-emitting units of the light-emitting module 4 can emit light to the optical element 43, and then the light can pass through the LCD panel 5. When the display device 3 is a direct-type backlight module, the optical element 43 is a diffuser. When the display device 3 is an edge-type backlight module, the optical element 43 is a light-guiding plate. Moreover, the light-emitting module 4 can further include other components (not shown) such as the reflective plate, optical film, quantum dot film, or the likes. To be noted, the above-mentioned LCD panel 5, diffuser, light-guiding plate, reflective plate, optical film, quantum dot film, and other components, materials and configurations of the backlight module are well-known knowledges of the skilled persons in the art, so the detailed descriptions thereof will be omitted.

As shown in FIG. 4B, the display device 3a includes all components and technical features of the display device 3 and a touch electrode structure 6. The touch electrode structure 6 is disposed inside the LCD panel 5, and the display device 3a is an in-cell touch display device.

As shown in FIG. 4C, the display device 3b includes all components and technical features of the display device 3 and a touch electrode structure 6. The touch electrode structure 6 is disposed on the LCD panel 5, and the display device 3b is an on-cell touch display device.

As shown in FIG. 4D, the display device 3c includes all components and technical features of the display device 3 and a touch panel 7. The LCD panel 5 is disposed between the touch panel 7 and the light-emitting module 4, and the display device 3c can be an out-cell touch display device or an OGS (one glass solution) touch display device.

In summary, each light-emitting unit of the light-emitting module in the display device of the disclosure includes a plurality of lighting regions, and at least two of the lighting regions in each one of the light-emitting units are connected to at least two driving units. The plurality of lighting regions connected to the same one of the driving units are connected to the current balance unit corresponding to the driving unit. This configuration can effectively prevent the loading peak from focusing on one set of driving units. Accordingly, the display device of the disclosure can improve the issue that the loading of the light-emitting module is highly focused on one set of driving units of the driving circuit in the high dynamic contrast application.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A display device, comprising:
a first light-emitting unit comprising a first lighting region and a second lighting region;
a first driving unit and a second driving unit, wherein the first driving unit is electrically connected to the first lighting region, and the second driving unit is electrically connected to the second lighting region; and
a first current balance unit and a second current balance unit, wherein the first current balance unit is electrically connected to the first lighting region, and the second current balance unit is electrically connected to the second lighting region.

2. The display device of claim 1, wherein the first light-emitting unit further comprises a third lighting region electrically connected to the first driving unit and the first current balance unit.

3. The display device of claim 1, wherein the first lighting region comprises at least one light-emitting diode, and the second lighting region comprises at least one light-emitting diode.

4. The display device of claim 3, wherein the first lighting region comprises a plurality of light-emitting diodes electrically connected in serial, in parallel, or in serial and parallel, and the second lighting region comprises a plurality of light-emitting diodes electrically connected in serial, in parallel, or in serial and parallel.

5. The display device of claim 1, wherein the first lighting region and the second lighting region share a common anode or a common cathode.

6. The display device of claim 1, wherein the first driving unit is DC-to-DC convertor or AC-to-DC convertor, and the second driving unit is DC-to-DC convertor or AC-to-DC convertor.

7. The display device of claim 1, further comprising a controller, wherein the controller is electrically connected to the first driving unit, the second driving unit, the first current balance unit, and the second current balance unit.

8. The display device of claim 1, wherein first light-emitting unit comprises a plurality of lighting regions arranged in an array.

9. The display device of claim 1, further comprising a second light-emitting unit, wherein the second light-emitting unit is located around the first light-emitting unit, and the second light-emitting unit comprises a plurality of lighting regions.

10. The display device of claim 1, further comprising a display panel, wherein the display panel is located corresponding to the first light-emitting unit.

11. The display device of claim 10, further comprising an optical element, wherein the optical element is located between the display panel and the first light-emitting unit.

12. The display device of claim 11, wherein the display panel comprises a touch electrode inside.

13. The display device of claim 12, wherein the light-emitting module further comprises an optical element disposed corresponding to the display panel.

14. The display device of claim 13, further comprising:
a touch electrode structure disposed inside or on the display panel.
